(19) United States
(12) Patent Application Publication
(10) Pub. No.: US 2010/0174510 A1
(43) Pub. Date: Jul. 8, 2010

(54) Method and System for Generating and Providing Seating Information for an Assembly Facility with Obstructions

(76) Inventor: Franklin L. Greco, Pepperell, MA (US)

Correspondence Address: Franklin L. Greco, 174 Hollis St, Pepperell, MA, 01463, US

(21) Appl. No.: 12/652,023

(22) Filed: Jan. 4, 2010

Related U.S. Application Data
(60) Provisional application No. 61/204,345, filed on Jan. 5, 2009.

(51) Int. Cl. G06F 17/50; G06F 3/048

(52) U.S. Cl. 703/1; 715/851

(57) ABSTRACT

A method and system for generating and providing accurate seating information for each seat in an assembly facility are disclosed. The method, and the corresponding components of the system that perform the method, includes determining the position of a seat in an assembly facility, determining the position of an obstruction in the assembly facility, determining an obstructed area based on the positions of the seat and the obstruction, and generating seating information based on the obstructed area. A server for providing seating information, which may include an image file that includes detailed graphical views and/or textual information regarding obstructions for a particular seat, is also disclosed. The server is configured to receive a seating information request for a selected seat from a client. The server is also configured to fetch from memory the detailed seating information for the selected seat and transmit it to the client.

### CROSS-REFERENCE TO RELATED APPLICATIONS

This application claims the benefit of and priority to U.S. Provisional Application Ser. No. 61/204,345, filed on Jan. 5, 2009, entitled “METHOD FOR CALCULATING AND DISPLAYING PRECISE STADIUM AND THEATER SEATING VIEWS WITH OBSTRUCTION INFORMATION,” the entire contents of which are hereby incorporated herein by reference.

### BACKGROUND

1. Technical Field

The present disclosure relates to a method and system for generating and providing seating information for seats in an assembly facility and, in particular, a method and system for generating and providing computer-graphical views and textual information associated with each seat in an assembly facility that includes obstructions.

2. Background of Related Art

Sporting events, theatrical performances, concerts held in assembly facilities throughout the world are attended by millions of people each year. People want to know as much information as possible about a seat in the assembly facility before they purchase a ticket for that seat. People often complain when they pay a significant amount of money for a ticket and then they have a bad experience because their view of the main viewing area (e.g., a field in the case of a baseball or football assembly facility) is poor or does not meet expectations. They may be too far away from the field, they may have difficulty with aisle traffic blocking their view, and they may have no shelter from rain.

The most significant problems come from permanent obstructions that block people's view of an event in an assembly facility. A pole, a wall, or some other obstruction blocking a person's view of a sporting or other event can be frustrating. Everyone in the facility is cheering except for the person sitting behind an obstruction. This person is left to wonder what the exciting play was that they missed. Thus, people want as much information as possible about a particular seat to avoid these types of situations or at least know about them before they pay a significant amount of money for a ticket.

The majority of seating diagrams provided by assembly facility owners and ticket vendors are two-dimensional charts. These charts are only roughly to scale, show general seating sections and otherwise make no attempt to be precise. It is often difficult to get a good idea of where the seat is located. These charts do not include information about the view from each seat in the assembly facility, such as obstruction information. Occasionally a statement is made about a seat having a badly obstructed view without providing any detailed information. Sometimes assembly facility owners provide pictures or photos of the view from the perspective of a single seat in each seating section with the best view of the field. However, other seats in the same seating section may have a poor view of the main viewing area because of obstructions or other factors or features of the assembly facility. Therefore, these pictures or photos taken from the perspective of a single seat in a seating section are often only representative of a small percentage of the seats in the seating section.

More elaborate seating diagrams of the prior art are focused on detailed three-dimensional views from seating sections or portions of seating sections. Here, again, there has been no attempt to provide seating information that includes three-dimensional graphical views for each individual seat. The three-dimensional graphical views are taken from the perspective of a single seat in a seating section, but represent the view for an entire seating section or portion of a seating section. For these reason, assembly facility owners or other persons that promote ticket sales provide a disclaimer that obstructions are not represented. Any information regarding the impact of obstructions on the view from a particular seat is ignored. The seating diagrams do not attempt to provide a description of the obstructed area or any details about the obstruction. Accordingly, there is a need to present detailed and accurate information regarding each individual seat in an assembly facility including obstruction information.

### SUMMARY

The present disclosure, in one aspect, features a computer-implemented method and system of accurately generating and providing seating information for each seat in an assembly facility, including information regarding the view from each particular seat. This seat information may be presented in a graphical and/or textual manner to provide the most complete and detailed information for each seat. The seating information may highlight those portions of the view that are obstructed by obstructions such as poles, walls, light towers, screens, and netting. The seating information may include multi-dimensional graphical views showing how the view from each seat in the assembly facility is impacted by obstructions or other features of the assembly facility.

The computer-implemented method of generating seating information associated with a seat in an assembly facility includes determining the position of a seat in an assembly facility, determining the position of an obstruction in the assembly facility, determining an obstructed area based on the positions of the seat and the obstruction, and generating seating information based on the obstructed area. In some embodiments, determining an obstructed area includes generating a set of projection lines extending from the seat through edges of the obstruction. Determining an obstructed area may further include determining a set of intersection points formed by the set of projection lines intersecting with a perimeter of a main viewing area. Determining an obstructed area may further include determining a polygon that defines the obstructed area based on the set of intersection points.

The computer-implemented method of generating seating information associated with the seat in the assembly facility may further include displaying the seating information through a graphical user interface. The assembly facility may be an arena, coliseum, concert hall, convention center, events center, lecture hall, opera house, race track, sports venue, stadium, theater, or velodrome.

In some embodiments, the seating information includes three-dimensional perspective views of the main viewing area. The seating information may also include obstruction information that is presented in the form of two-dimensional graphics, three-dimensional graphics, or text describing the obstructed area (e.g., text describing the percentage of the view area that is obstructed).

The computer-implemented method may also include calculating a distance between at least two positions in the assembly facility and displaying the value of the distance.

In some embodiments, determining the position of a seat in the assembly facility includes determining the coordinates for the perimeter of a field of the assembly facility, determining the coordinates for the first seat in a seating section based on the coordinates for the perimeter of the field, and determining the coordinates of a second seat in the seating section based on the coordinates of the first seat.

The present disclosure, in another aspect, features a server for providing seating information associated with a seat in an assembly facility. The server includes a memory configured to store seating information associated with each seat in an assembly facility. The seating information includes information regarding obstructions. The server also includes a communications interface configured to receive a seating information request for a selected seat from a client. The server also includes a processor that transmits seating information associated with the selected seat to the client via the communications interface in response to the seating information request.

In some embodiments of the server, the seating information includes graphical views of a viewing area and seating sections. In some embodiments, the seating information is contained in an image file. The image file may include at least one three-dimensional perspective view from the seat in the assembly facility and textual information regarding the obstruction.

The present disclosure, in another aspect, features a computer system for generating and providing seating information associated with a seat in an assembly facility. The computer system includes a computer configured to determine the position of a seat in an assembly facility, to determine the position of an obstruction in the assembly facility, to determine an obstructed area based on the positions of the seat and the obstruction, and to generate seating information based on the obstructed area.

The computer system also includes a server in communication with the computer. The server is configured to receive the seating information from the computer and to store the seating information in memory. The server is also configured to transmit the seating information to a client in response to a request from the client.

In some embodiments, the seating information is an image file. The image file may include at least one three-dimensional perspective view from the seat in the assembly facility and textual information regarding the obstruction. The textual information may include at least one of the percentage of the viewing area that is obstructed and the identification of objects that are obstructed.

In some embodiments, the computer determines the position of the seat in the assembly facility by determining coordinates for a perimeter of a field in the assembly facility, determining coordinates for a first seat in a section of the assembly facility based on the coordinates for the perimeter of the field, and determining the coordinates for the seat in the assembly facility based on the coordinates for the first seat in the section. In some embodiments, the server includes the computer.

Thus, the disclosed method and system provide highly accurate seating information for each seat in an assembly facility that includes graphical and/or textual information. This information provides people with a clear understanding of all the details and potential issues regarding each seat in the assembly facility.

### BRIEF DESCRIPTION OF THE DRAWINGS

Various embodiments of the subject instrument are described herein with reference to the drawings wherein:

FIGS. 1A-1B are functional block diagrams of computer systems for generating and providing seating information, including computer graphical views of an assembly facility from the perspective of individual seats in the assembly facility, in accordance with embodiments of the present disclosure;

FIGS. 2-5 are flow diagrams of processes for generating seating information for individual seats in an assembly facility in accordance with embodiments of the present disclosure;

FIG. 6 is a diagram illustrating example shapes of seating sections in accordance with embodiments of the present disclosure;

FIGS. 7-12 are diagrams illustrating computer-implemented methods for determining obstructed areas in accordance with embodiments of the present disclosure; and

FIGS. 13 and 14 are illustrations of image files in accordance with embodiments of the present disclosure.

### DETAILED DESCRIPTION

Embodiments of the presently disclosed method and system for generating seating information, including graphical views of the main viewing area of an assembly facility, for individual seats in the assembly facility are now described in detail with reference to the drawings, in which like reference numerals designate identical or corresponding elements in each of the several views.

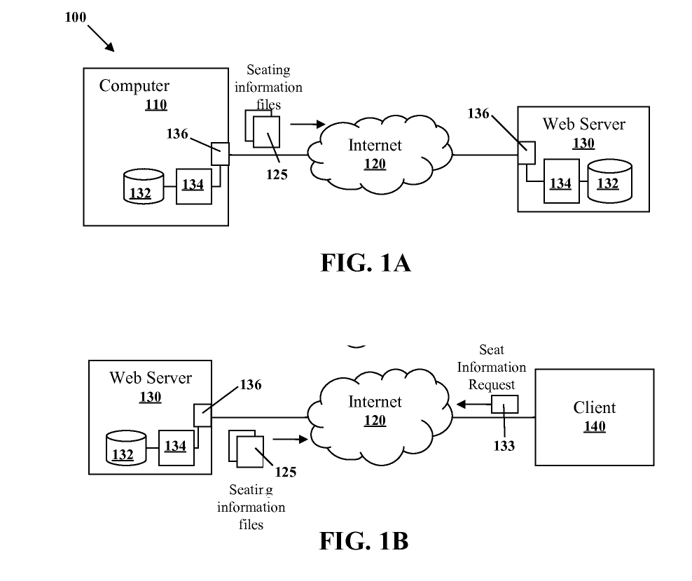

FIG. 1A is a functional block diagram of a computer system 100 for generating seating information for an assembly facility for individual seats in the assembly facility in accordance with embodiments of the present disclosure. The computer system 100 includes a computer 110 and a web server 130 in communication with the computer 110 via the Internet 120.

The computer 110 and the web server 130 may include a memory 132, a processor 134, a communications interface 136, and input/output devices (not shown). The processor 134 may include at least one conventional processor or microprocessor that interprets and executes instructions. The processor 134 may be a general purpose processor or a special purpose integrated circuit, such as an ASIC (application-specific integrated circuit), and may include more than one processor sections.

The memory 132 may be a random access memory (RAM) or another type of dynamic storage device that stores information and instructions for execution by the processor 134. The memory 132 may also include a read-only memory (ROM) which may include a conventional ROM device or another type of static storage device that stores static information and instructions for the processor 134. The memory 132 may be any memory device that stores data for use by system 100.

Additionally, the computer 110 and/or the web server 130 may include input/output devices (I/O devices) (not shown). The I/O devices may include one or more conventional input mechanisms that permit a user to input information to the computer 110 and/or the web server 130, such as a microphone, touchpad, keypad, keyboard, mouse, pen, stylus, voice recognition device, or buttons, and output mechanisms, such as one or more conventional mechanisms that output information to the user such as a display, one or more speakers, a storage medium (e.g., a memory, magnetic or optical disk, or disk drive), or a printer device.

The computer 110 generates seating information for each seat in an assembly facility based on assembly facility information provided to the computer 110. In other embodiments, the server 130 may generate the seating information. For example, a third party may upload files containing assembly facility information, such as overhead images of the assembly facility, to the server 130. Then, the server 130 may process the assembly facility information and generate seating information.

The computer 110 may generate the seating information offline to increase the speed of accessing the seating information online. For example, the computer 110 may generate a large number of image files (e.g., over 100,000), each of which may include graphical perspective views and textual information for a particular seat in the assembly facility (e.g., a stadium). The image files may be saved as Portable Network Graphics (.png) files, which are files with a format similar to Graphics Interchange Format (.gif).

In other embodiments, the graphical perspective views and textual information for each seat may be displayed through a graphical user interface. For example, the client 130 may access the graphical perspective views and textual information for each seat through a graphical user interface of a website hosted by the server 130.

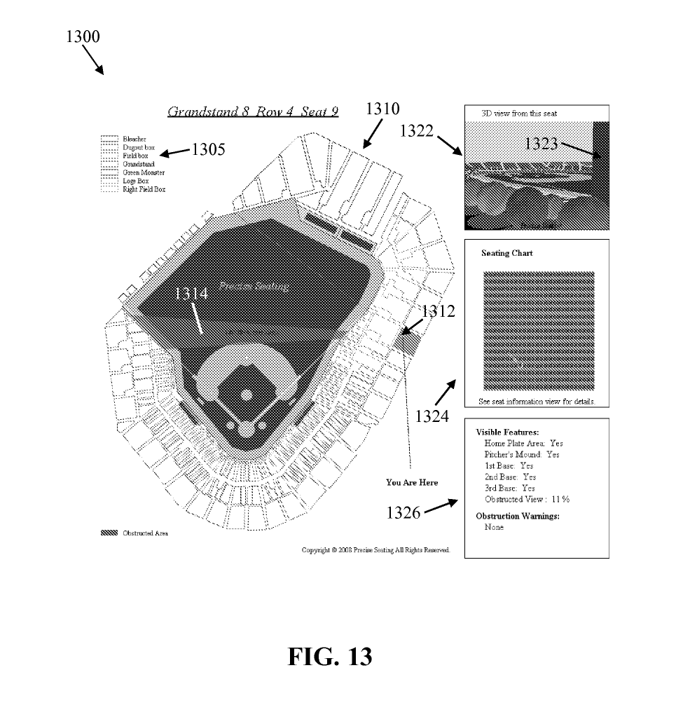

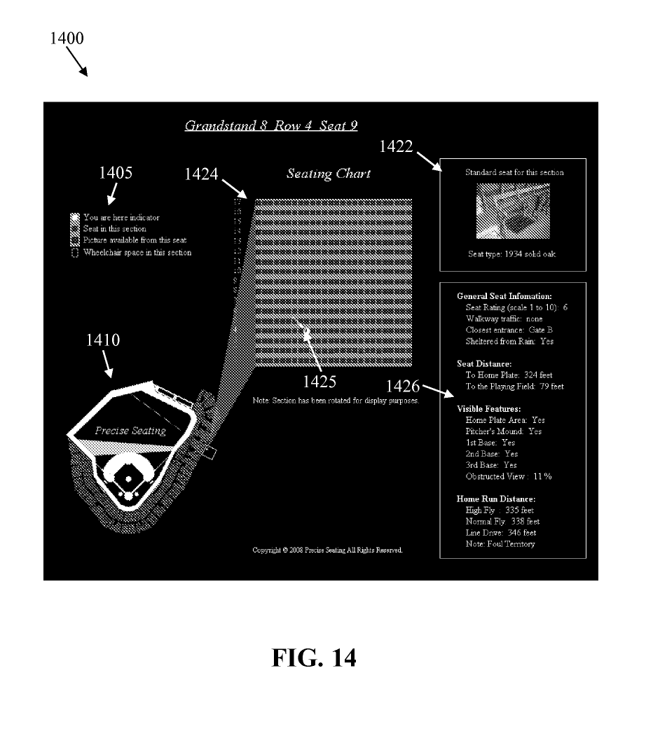

Each seat may have any number of seating information files, such as image files, to convey actual information regarding the view from the perspective of each seat. The name of each file may uniquely identify it with a particular seat in an assembly facility. For example, a seat located in Grandstand section 8, row 4, seat 9 may be associated with the following three assembly facility information files:
Grandstand8row4seat9.png—an overview image (e.g., FIG. 13)
Grandstand8row4seat9_sv.png—seat information image (e.g., FIG. 14)
Grandstand8row4seat9_pv.png—overview (printable) image

The image files may include two-dimensional maps and three-dimensional views from the perspective of each seat in an assembly facility. The image files may also include other seating information including the exact location of the seat, the distance of the seat to features of the field such as the home plate in baseball or the end zone in football, information regarding pole and wall obstructions, difficult viewing angles, walkway advisory information, information regarding whether obstructions block the view of the home-plate or the pitcher's-mound for baseball, information regarding in-field obstructions, large obstructed areas, home-run distances, information regarding backstop netting and screens, obstructed area ratios (e.g., the area that is blocked from view by the obstruction divided by the total area of the field or main viewing area), the closest entrance, information regarding whether the seat is sheltered from rain, a zoom-in view of a seat in a seating section, and pictures of the seat.

The computer 110 uploads seating information files 125, including image files, associated with each seat in an assembly facility, to the web server 130 via the Internet 120 and the communications interfaces 136. The web server 130 stores the seating information files 125 in its memory 132. The seating information files 125 may be stored on the web server 130 in specific directories according to seating sections in an assembly facility.

FIG. 1B is a functional block diagram illustrating how a user may access the seating information files 125. A client computer 140 transmits a seat information request 133 to the web server 130 via the Internet 120. In response, the processor 134 of the web server 130 fetches the seat information files 125 associated with the particular seat identified in the seat information request 133 and sends them to the client 140 via the Internet 120.

A user may transmit a seat information request 133 via commands entered in a webpage that is displayed by the client computer 140. The webpage may present options so that a particular seat or a group of seats may be identified and selected. A user may view the seating information files through the webpage. The webpage may provide tabs to facilitate jumping between portions of the seating information files about a particular seat or group of seats.

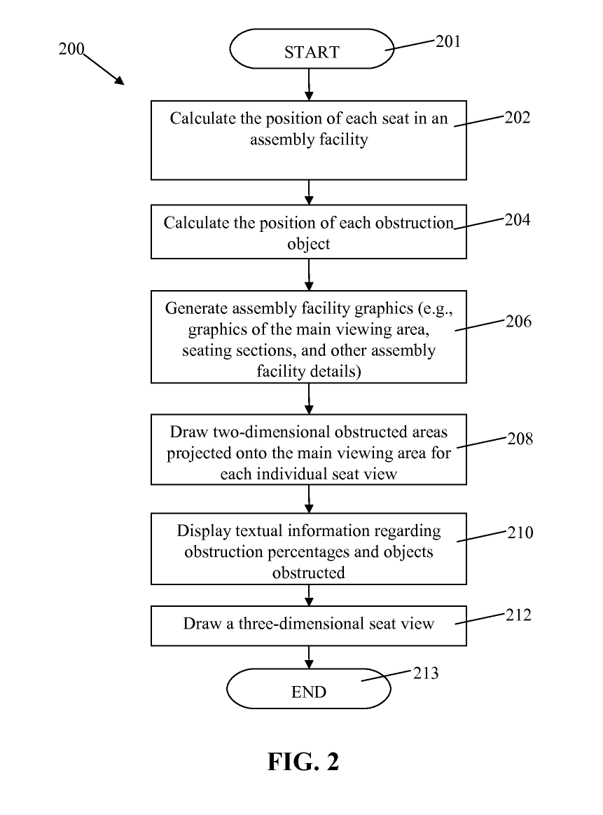

FIG. 2 is a flow diagram of a computer-implemented process 200 for generating seating information including computer graphical views of an assembly facility from the perspective of each individual seat in an assembly facility. After the process 200 starts 201, the X, Y, Z coordinates of each seat in the assembly facility (e.g., a stadium) are determined 202. In some embodiments, the coordinates of each seat are determined with accuracy. If the seat locations are not determined with accuracy, it may become quickly apparent because the seating sections will not fit together correctly and will not wrap around the stadium perimeter correctly.

Once the locations of seats are determined, in step 204 the coordinates for the locations of all the obstructions are determined. This is accomplished by determining the distances between the obstructions and each seat in the assembly facility. Distances may be determined by analyzing photographs and measuring distances from a particular seat. The locations of obstructions may be adjusted by comparing to actual photographs from particular seats in a section.

In the case of wall obstructions, the distances between points along the length of the wall are determined. One accurate way to find the coordinates for an obstruction is to calculate its distance from the nearest seat. For example, when a pole obstruction is near a seat, the pole position may be determined to within a few inches of its actual location relative to the seat. As a result, the obstructed area may be calculated with accuracy. Otherwise, the obstructed area (e.g., the area formed by the lines 710a-b of FIG. 7 projected out hundreds of feet from the pole obstruction 704) may be inaccurate.

In step 206, assembly facility graphics, which represent the main viewing area, the seating, and all the surrounding details, are generated. Key features of the main viewing area are analyzed so that the system can determine whether they fall within an obstructed area (e.g., the obstructed area 708 of FIG. 7). For example, the coordinates of the pitcher's mound in a baseball stadium can be analyzed to determine whether or not it falls within an obstructed area. This information can then be incorporated into the seating information files.

In step 208, the two-dimensional obstructed areas projected onto the main viewing area are drawn for each individual seat view. As lines are projected out from a seat past the edge of an obstruction, they intersect with the perimeter of the main viewing area. These intersection points together with any additional perimeter points within the projected lines will form a polygon that defines the obstructed area (see, e.g., FIG. 10 below).

Once all the coordinates of the seats, obstructions, obstructed areas, and main viewing area objects have been calculated, this information can be analyzed. In step 210, all the textual information regarding seat distances, obstruction percentages, objects obstructed from the view of the seat, and other useful information associated with each seat is displayed.

Finally, in step 212, before the process 200 ends 213, three-dimensional objects and three-dimensional views from each seat looking towards a central point on the main viewing area are generated based on the calculated coordinates of seating, obstructions, obstructed areas, and main viewing area objects.

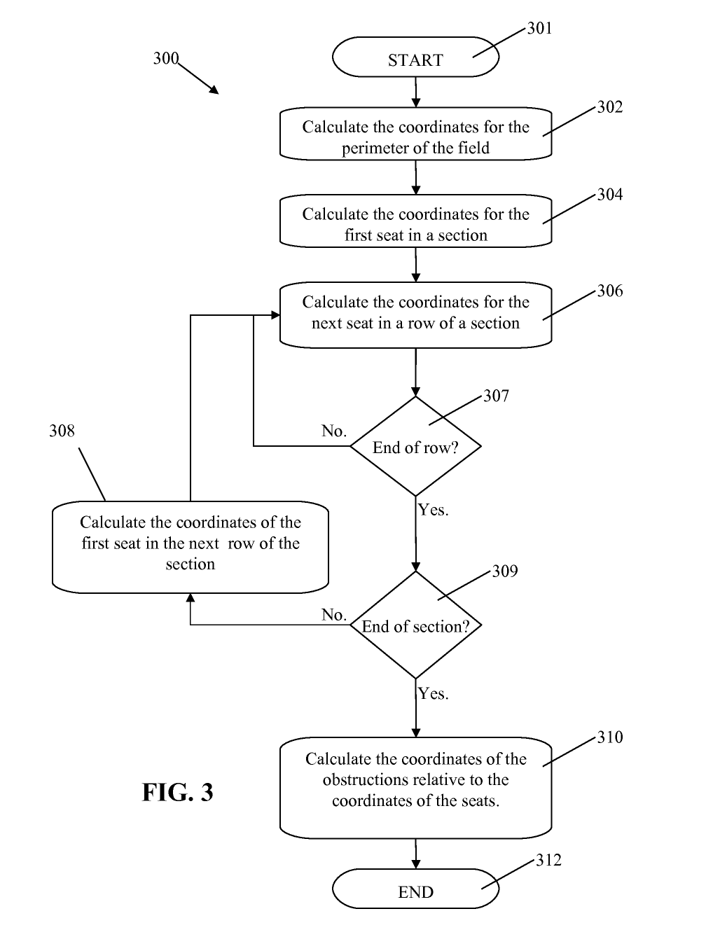

FIG. 3 is a flow diagram of a process 300 for finding the location of each seat in an assembly facility. In step 301, the process 300 starts. In step 302, all the vertices that define the polygon representing the perimeter of the main viewing area or field are determined. In step 304, the coordinates of a starting seat location for each seating section are determined. This may be done by using some known point on the perimeter or a known coordinate of another seat and then calculating the correct distance to the starting seat location in a seating section of an assembly facility.

In steps 306-309, the three-dimensional coordinates of the remaining seats in the seating section are determined based on the position of the starting seat in the section and other information regarding the section, such as how the seating section is oriented in an assembly facility. The position of each seat may be calculated using a distance metric to calculate the position of each seat in a row relative to the position of the starting seat.

In step 306, the coordinates for the next seat in a row of a seating section are calculated. In step 307, if it is determined that the end of the row has not been reached, then step 306 is repeated for another seat in the row of the seating section. Otherwise, it is determined whether the end of the seating section has been reached 309 (i.e., the coordinates of all seats in the seating section have been calculated). If the end of the section has not been reached, then the coordinates of the first seat in the next row of the section is calculated and steps 306-309 are repeated until the end of the section is reached.

When moving from row to row to calculate the coordinates of each seat in the assembly facility, the shape of the section may be taken into account. Each section may be identified as one of several shapes that define the length of each row and how the rows in a section relate to one another. In some embodiments, a computer program for generating the coordinates of seats includes a section generator routine that takes the number of seats in each row from an array that represents the section of an assembly facility. The array index represents the row number and the value for each row represents the number of seats in each row. This array may be manually entered into the computer program that generates the seating information. Lastly, in step 310, the coordinates of obstructions are calculated relative to the coordinates of seats. The process 300 then ends in step 312.

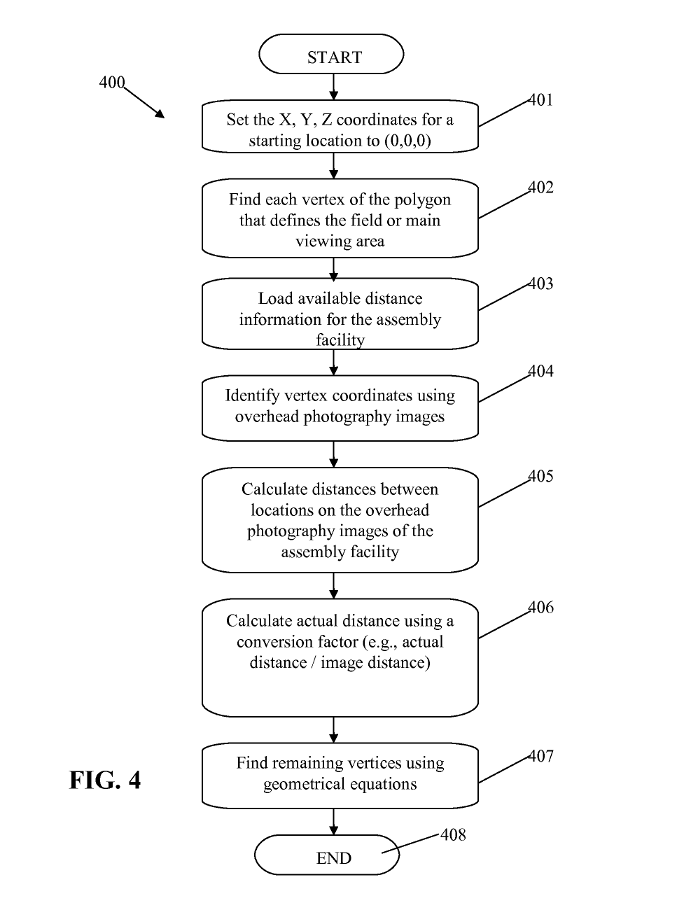

FIG. 4 is a flow diagram of a process 400 for generating accurate seating information for individual seats in an assembly facility in accordance with embodiments of the present disclosure. To determine the perimeter of the field, a starting location is selected 401 with the X, Y, and Z coordinates set to (0,0,0). This starting location represents a central object or center location of the main viewing area. Examples of starting locations include, and are not limited to, the home plate for a baseball stadium, the fifty-yard line for a football field, center stage for a theater, and center court for a basketball court. Objects defined in any assembly facility may have coordinates relative to the starting location.

The perimeter of the main viewing area or field may be used to calculate the coordinates of objects in the assembly facility. For example, the vertices of the perimeter of the main viewing area may be used for determining the seating section angles (i.e., the orientation of the seating section in an assembly facility), calculating coordinates of the first seat in a section, drawing field graphics, and finding intersection points when determining the obstructed area.

In step 403, available distance information for the assembly facility is loaded. For example, sporting stadiums often mark certain distances of the field. For example, the outfield walls in a baseball stadium are marked with distances from the outfield walls to home plate. These distances can be used to identify some of the vertices of the perimeter of the assembly facility. They can also be used to obtain a starting point for measuring distances in overhead imagery.

In step 404, coordinates of locations in the assembly facility are identified using overhead images of the assembly facility. For example, coordinates of the vertices of the perimeter of the assembly facility may be determined using overhead imagery, such as Google Earth satellite images or aerial photography, and using geometrical equations to derive points from other known points, distances and angles. An image can be pulled into a software program (e.g., Microsoft Point or Photoshop) that shows pixel coordinates at the mouse location. Once two known actual field coordinates are identified, the pixel coordinate information can be used to make the conversion from the overhead image distances to the actual field distances.

In step 405, the image distances are determined by using the standard distance formula to find the distance between two points. For example, given the X and Y coordinates of two points in an assembly facility, the distance between the two points is calculated by summing the square of the difference of the X values and the square the difference of the Y values and taking the square root of the resulting sum. This distance is the pixel distance between the two points. In step 406, a conversion factor is used for the conversion from the overhead image distances to the actual distances. The conversion factor is simply the actual distance divided by the image distance for the two points.

Many points in an assembly facility can be found using an overhead image and the steps described above, but often there is a need to use geometrical equations (step 407) for accuracy and to fill in any remaining vertices. The law of cosines is one equation that is used when three sides of a triangle are known.

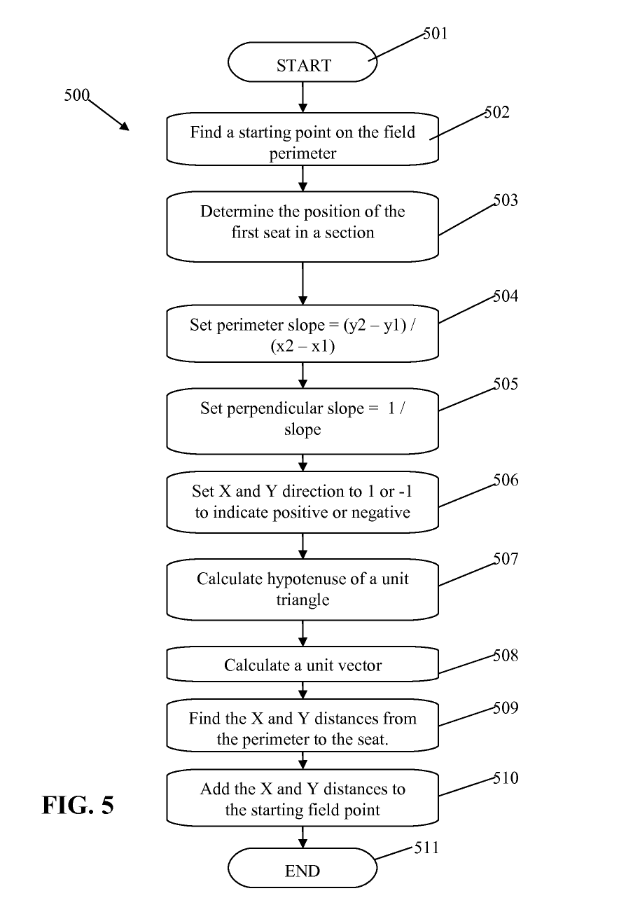

Once the perimeter of the main viewing area is determined, the position of the first seat for each section in the assembly facility is determined. FIG. 5 is a flow diagram of a process 500 of determining the coordinates of a first seat in a section based on a known point on a perimeter segment (e.g., perimeter segment 1003 of FIG. 10). After the process 500 starts 501, the coordinates of a starting point on the perimeter of the viewing area (e.g., baseball field) is found 502. Then, in step 503, the position of the first seat in a section is determined. In some embodiments, the first seat is the seat that is close to one of the vertices of the perimeter of the view area.

In step 504, the slope of a perimeter segment is determined. Then, in step 505, the slope of a line perpendicular to the perimeter segment is calculated by calculating the inverse of the slope of the perimeter segment (i.e., 1/slope). The sign of the perpendicular slope may be ignored. In step 506, the X and Y direction are then set to positive or negative. In step 507, the hypotenuse of a unit triangle is calculated (e.g., hypotenuse=square root of (x*x+y*y); assume that x=1 and y=slope; hypotenuse=square root of (1+slope*slope)). In step 508, a unit vector is calculated using similar triangles (e.g., (vector X, vector Y)=((1/h)*X direction, (slope/h)*Y direction)). In step 509, the X and Y distances from the perimeter to the seat are found (e.g., (distance X, distance Y)=(vector X*distance to seat, vector Y*distance to seat)). Finally, before the process 500 ends, the X and Y distance to the known vertex point (e.g., the starting field point) is added to the vertex point (e.g., (new X, new Y)=(starting point X+distance X, starting point Y+distance Y)). This results in a new coordinate that represents the position of the starting seat. The starting seat for a section may also be determined based on the coordinates of another seat or another object in the assembly facility using the above process 500.

In some embodiments, patterns in seating sections are identified and used to determine the locations of seats in the seating sections. For example, in some assembly facilities, the seat width, the row depth, the row height, the isle width, the number of seats per row, and other seating section parameters are consistent throughout a seating section or multiple seating sections. The coordinates of other seats in a seating section can be determined by using seating section parameters and executing the process 500 with the exception that the starting position is not the perimeter.

For example, setting the starting point as the position of the starting seat or another seat with known coordinates, the position of the next seat in the same row is calculated based on the seat-width value (e.g., multiply the unit vector determined in step 507 by the seat width value). When the positions of all seats in a row have been determined, the position of the next seat in the next row is calculated based on the row-depth value. In some embodiments, each time a new row is encountered, a row height value is added to a base height value for the section to obtain the Z coordinate. The above processes are repeated until the positions of each seat in each section are calculated for an assembly facility.

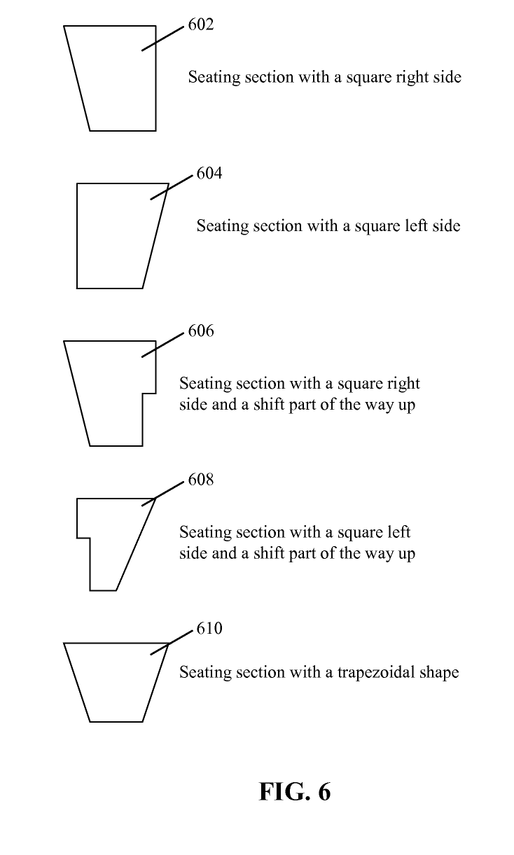

In some embodiments, the seating section parameters used to calculate the coordinates of seats include the shape of the seating section. The shape of the seating section is used when moving from row to row to obtain the correct seating arrangement for each row. Some examples of different types of seating section shapes are identified in FIG. 6. The square-right-side section 602 has the right side of the rows aligned with a vertical line. Similarly, the square-left-side section 604 has the left side of the rows aligned with a vertical line. The shifted-square-right-side section 606 is the same as the square-right-side section 602 except that a portion of the vertical line is shifted left. Similarly, the shifted-square-left-side section 608 is the same as the square-left-side section 604 except that a portion of the vertical line is shifted right. The trapezoidal seating section 610 has a trapezoidal shape when each seating row is longer on both sides than the previous row.

In some cases, where seats are missing in the middle of the row or seat numbering is not in a continuous sequence, the seating sections are handled individually and adjusted accordingly.

Once the coordinates for all seats in an assembly facility are determined, the coordinates for obstructions are determined. The coordinates of the seats and/or points on the perimeter of the assembly facility can be used since obstructions are normally located on the perimeter or in the seating area in the form of a wall, pole, or other object. Some actual measurements by hand may be done to determine the distance from a particular seat to the obstruction.

In some embodiments, to determine the coordinates of an obstruction, a process similar to process 500 of FIG. 5 is executed based on the known coordinates of a seat or other object. First, the slope of the perimeter segment and the slope of a line segment perpendicular to the slope of the perimeter segment are calculated. Next, the X and Y direction are set, the hypotenuse of a unit triangle is calculated, a unit vector is calculated using similar triangles, and the X and Y distances are calculated. This results in coordinates that represent the position of the obstruction. Depending on the obstruction, a center point or end points are used to accurately identify the obstruction's position in the assembly facility.

The methods and systems according to embodiments of the present disclosure calculate polygons that represent obstructed areas of the main viewing area. The first type of obstruction that may be calculated is a pole obstruction. In general, pole obstructions are either round, square or rectangular. But no matter the type of pole obstruction, the two outermost points of the obstruction are calculated (i.e., the outermost points of the obstruction that block the view from a particular seat) to determine the obstructed area.

Referring to FIG. 7, for a round pole obstruction 704 having a known center point, the coordinates of the outer edges of the obstruction is determined by first forming a straight line 703 from the center of the seat 702 to the center of the round pole obstruction 706. Then, from the center of the pole 706, move a distance of half the width of the pole in a direction perpendicular to the line created between the pole and the seat. Lastly, lines are projected from the seat center through each of the outer edges to form two projected lines 710a-b.

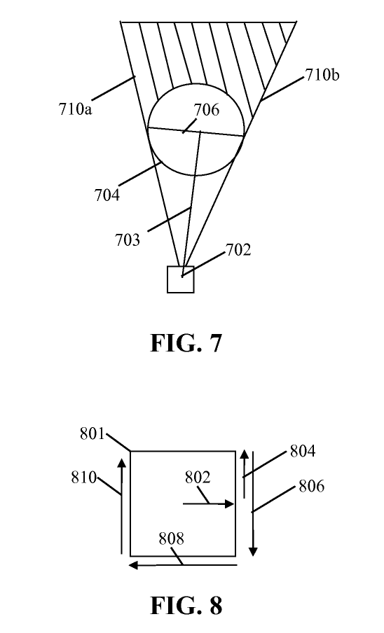

Referring to FIG. 8, for a square or rectangular obstruction 801, the coordinates of the corners of the obstruction 801 are determined by first moving a distance of half the width of the obstruction 801 from the center point of the obstruction 801 in a direction parallel to one of the sides of the obstruction 801 as illustrated by the arrow 802. In this way, the coordinates of the midpoint of the outer edge of the obstruction 801 are determined. Then, the coordinates of the first corner are determined by moving half the length of the obstruction 801 along the outer edge of the obstruction 801 in a direction perpendicular to the direction of arrow 802 as illustrated by the arrow 804. The coordinates of the remaining corners are found by moving a distance of the length or width of the obstruction 801 around the outer edges of the obstruction 801 in the direction of the arrows 806-810.

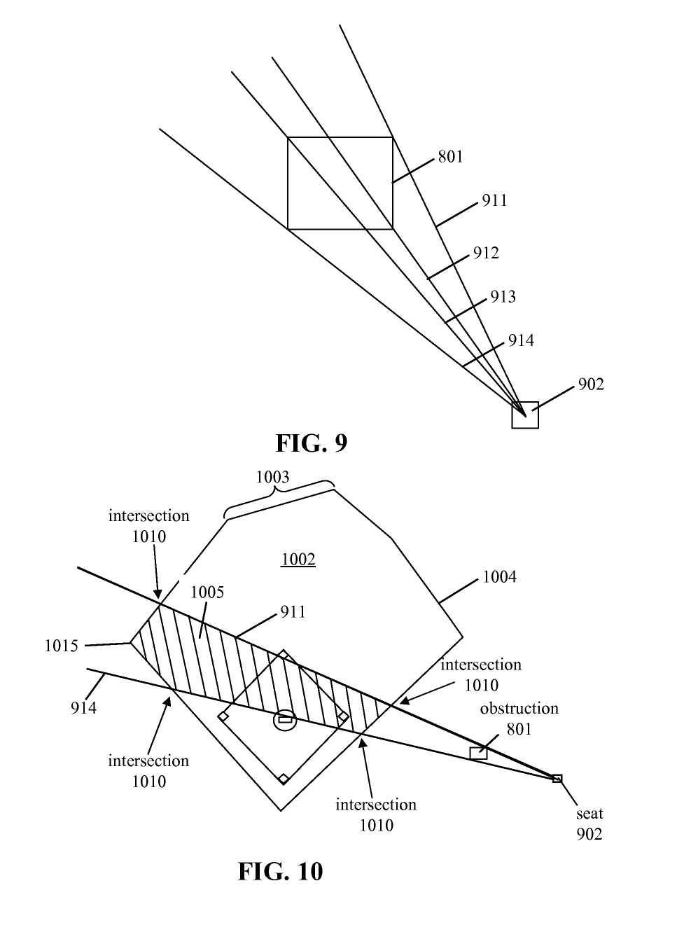

Referring now to FIG. 9, four lines 911-914 are drawn from the center of a seat 902 through the four corners of the square or rectangular obstruction 801. The distances from the center of the square or rectangular obstruction 801 to the closest point on each of the four lines is then determined. The two lines that are the greatest distance from the center of the obstruction 801 (e.g., 911 and 914) are used to determine the obstructed area.

With the lines 911 and 914 projected from the seat 902 through two corners of the obstruction 801, the obstructed portion of the main viewing area (e.g., 1002 of FIG. 10) can be determined. Referring to FIG. 10, the obstructed portion 1005 is determined by first finding where the projected lines 911, 914 intersect with the perimeter 1004 of the main viewing area 1002 (e.g., baseball field). The perimeter 1004 is an array of line segments. Thus, each line segment of the perimeter 1004 is compared with the projected lines 911, 914 to find intersection points 1010. The points of intersection 1010 and the point 1015 (i.e., corner) of the perimeter 1004 that is between the projected lines 911, 914 are then used to determine the obstructed area polygon 1005.

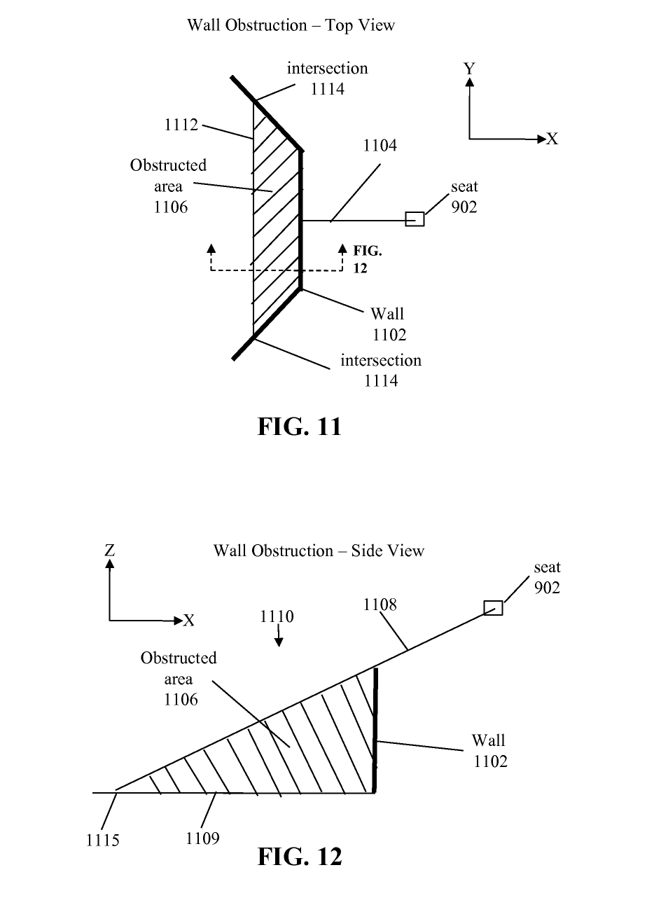

Another example type of obstruction is a wall obstruction. FIGS. 11 and 12 are diagrams of the top and side views of an example wall obstruction. In some assembly facilities (e.g., a baseball stadium), wall obstructions make up the perimeter of the main viewing area. To determine the obstructed area 1106, a line segment 1104 that is perpendicular to the wall 1102 is formed between the seat 902 and the wall 1102. The point of intersection between the wall 1102 and the perpendicular line segment 1104 may be determined using the following equations:

X=((−C1*B2)+(C2*B1))/((A1*B2)−(A2*B1)) and

Y=((−A1*C2)+(A2*C1))/((A1*B2)−(A2*B1)),

where A1 and A2 are the negative of the slopes of the first and second intersecting lines, B1 and B2 are 1, and C1 and C2 is the negative y-intercept of the first and second intersecting lines. These equations are derived using the general line equation Ax+By+C=0 for the two intersecting lines, where A is the negative of the slope of the line, B is 1, and C is the negative y-intercept. Once the x- and y-coordinates of the point of intersection has been calculated, the height of the wall provides the z-coordinate.

A line 1108 may be formed in three-dimensional space between a point above the center of seat 902 at eye level and a point on the top of the wall 1102. The line 1108 intersects with the main viewing area at point 1115 (where the Z coordinate is equal to zero) and forms a side of the obstructed area 1106. The other sides of the obstructed area 1106 include the wall 1102 and, in the case of a baseball stadium, the field 1109.

The point of intersection 1115 between the line segment 1108 and the main view area is determined by solving the following equation for X and Y with Z set equal zero: (X−X1)/(X2−X1)=(Y−Y1)/(Y2−Y1)=(Z−Z1)/(Z2−Z1) where X1, Y1, and Z1 are the coordinates of the top of the wall 1102 (i.e., where the line segment 1108 intersects with the wall 1102) and X2, Y2, and Z2 are the coordinates of a point above the center of the seat 902 at eye level. Solving for X and Y with Z set equal to zero results in the following equations: X=((X2−X1)*(−Z1/(Z2−Z1)))+X1 and Y=((Y2−Y1)*(−Z1/(Z2−Z1)))+Y1.

A line segment 1112 may be formed from the point of intersection 1115 and the slope of the wall. This line segment 1112 defines an edge of the obstructed area 1106. The line is extended in both directions sufficient to intersect the perimeter of the main viewing area. The point of intersection between the line segment 1112 and the perimeter of the main viewing area 1114 may be determined using the following equations:

X=((−C1*B2)+(C2*B1))/((A1*B2)−(A2*B1)) and

Y=((−A1*C2)+(A2*C1))/((A1*B2)−(A2*B1)),

where A1 and A2 are the negative of the slopes of the first and second intersecting lines, B1 and B2 are 1, and C1 and C2 is the negative y-intercept of the first and second intersecting lines. These equations are derived using the general line equation Ax+By+C=0 for the two intersecting lines, where A is the negative of the slope of the line, B is 1, and C is the negative y-intercept.

The two points of intersection 1114 at each end of the line segment 1112, along with all the perimeter points that fall between them, form the polygon of the obstructed area 1106 caused by the wall 1102. This obstructed area 1106 may be highlighted in an image file in a solid color to indicate that the area that cannot be viewed from a particular seat.

An obstruction that is a screen may be handled in the same way as a wall since a screen usually has the same shape. If the screen is higher than eye level from the perspective of the selected seat, the viewing area is drawn with a screen obstruction. The screen obstruction area or polygon may be drawn with lines representing the screen so that the user understands that they can see through the screen.

Obstructions in the form of netting, such as a backstop net or a field-goal net, are often oriented vertically and have a height such that they can be handled in the same manner as a round obstruction. The two outer points of the net can be found by locating the nearest seat to the net and moving the appropriate X and Y distances to the field perimeter where the netting is attached. Lines are formed from the selected seat through the two outer points of the netting obstruction and extended out until they intersect with the perimeter of the main viewing area. These intersection points along with perimeter points between them (e.g., the perimeter point 1015 of FIG. 10) define the polygon that makes up the netting obstruction in the same manner as round obstructions. Once the vertices of the polygon are defined, the polygon is drawn in the image file with lines to simulate netting.

Obstructions that do not fall into a convenient shape described above may be handled in the same manner as the obstructions described above with the following exception. Instead of one or two points being identified, all the vertices along the edge of the obstruction must be located and their coordinates calculated.

Once the vertices of the obstruction are identified, a line is drawn from the seat through each obstruction vertex point, one line for each vertex. Using the line intersection method and solving for z equal to zero, a set of X, Y coordinates are found which define a polygon representing the obstructed area.

FIG. 13 is an illustration of an image file 1300 in accordance with embodiments of the present disclosure. The image file 1300 may be an overview seat image that is presented to the user when the user selects a particular seat. The image file 1300 includes a legend 1305 that is color coded to show the general seating sections (e.g., Grandstand, Field Box, and Loge Box). The main graphic in the image file 1300 is a two-dimensional representation of the assembly facility, which includes a main viewing area, the seating sections, the position of a selected seat, and a visual representation of any obstructed areas. The seating sections themselves are wrapped around the field and each seating section is represented by a polygon in the case of the printable image or a set of dots (each dot representing a seat) in the case of a black-background overview image.

A selected seat 1312 is indicated by a colored or grayscale dot (e.g., a yellow dot) and the statement, “You Are Here.” The seating section that contains the selected seat may be highlighted by drawing the seating section in a gray background in the case of the printable image or a yellow outline in the case of the black background overview image. Any obstructions associated with the selected seat may be illustrated as colored polygons (e.g., colored polygon 1314) projected onto the main viewing area. In this case, the main viewing area is the grass and dirt portion of a baseball field. Inside the colored polygon 1314 are the words “obstructed area” to help the user identify the colored polygon 1314 as an obstructed area. The colored polygons 1314 may be drawn as semi-transparent objects so that field features can be identified in the obstructed areas.

The image file may include a three-dimensional image representing the view from the selected seat 1322. The three-dimensional view from the perspective of a selected seat is directed to a central point in the main viewing area and includes any objects causing obstructions such as a pole or wall 1323. People may be included in the three-dimensional image for a selected seat in a section so that the user can have a more complete perspective of the view from the selected seat. Occasionally, an actual picture is available showing the view from a given seat and this picture would replace the three-dimensional view. The total number of pictures from given seats represent a very small percentage of the total assembly facility.

Located below the three-dimensional view 1323 is a chart 1324 showing all the seats contained in a seating section. The individual seat that has been selected may be highlighted with a particular color (e.g., yellow) and with a colored arrow pointing to it. This provides the user with a perspective of the seating section and the user's location in the seating section.

Located below the seating section chart 1324 is a textual information box 1326 that highlights certain key features of the stadium that are of interest to the viewer. The textual information box 1326 may indicate whether or not certain field objects (e.g., home plate or pitcher mound) are visible. The textual information box 1326 also provides a percentage of the field of view that is obstructed by an obstruction. Specific obstruction warnings are also highlighted to warn the user of an obstruction that could affect the view from a selected seat. The obstruction warnings may include information about a particular object that is obstructed (e.g., home plate or pitcher's mound), a portion of the viewing area is obstructed (e.g., infield or large obstructed areas), difficult viewing angles, isle traffic problems, or other problems that might occur for the selected seat.

FIG. 14 is an illustration of another image file 1400 in accordance with embodiments of the present disclosure. When a particular seat is selected, the image file 1400 may include the seat information view. The seat information view may include more detailed information about the seat and the seating section. The seat information view may include a legend 1405 to help the user understand or more quickly navigate through the information presented in the seat information view.

A selected seat may be highlighted in any number of ways. For example, the seat view information may include a “You Are Here” indicator that is illustrated in a particular color. Also, different types of seats may be illustrated by different objects (e.g., a regular seat, a barstool, and a wheelchair slot). And actual pictures or photos of a selected seat may be highlighted with a green outline. Actual photos may be taken from various seats and presented in the overview seat image.

Located directly below the legend is a reduced-sized graphic of a two-dimensional view of the assembly facility 1410 with the seat location and obstruction information intact. This reduced-sized graphic help convey to the user the exact location of the seating section that has been selected. This seating section or chart 1424 may zoom in on the position of the seat 1425 and more clearly show some other features of the seating section. The row numbers of the section can be identified, seats with photos can be identified, and special seating for the section can be identified (e.g., handicap seating and barstool seating). In some embodiments, an actual picture of the type of seat for the section is presented 1422.

Below the picture of the type of seat is short description of the seat type (e.g., molded plastic and metal barstool). Directly below the seat picture is a section providing additional details about the seat 1426. This section may includes the seat rating, walkway advisory warning, entrance gate, sheltered from rain indicator, distance from the seat to the field, distance from the seat to home plate or key features in the main viewing area, visible feature information, obstructed area percentage, home run distances for seats in or near fair territory or other relevant information about the seat.

Embodiments as disclosed herein may also include computer-readable media for carrying or having computer-executable instructions or data structures stored thereon. Such computer-readable media may be any available media that may be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium which may be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods and techniques that are insubstantially different from those described above and/or in the appended claims are also intended to be within the scope of the disclosure.

What is claimed is:

1. A computer-implemented method of generating seating information associated with a seat in an assembly facility, comprising:
determining the position of a seat in an assembly facility;
determining the position of an obstruction in the assembly facility;
determining an obstructed area based on the positions of the seat and the obstruction; and
generating seating information based on the determined obstructed area.

2. The method according to claim 1, wherein determining an obstructed area includes generating a set of projection lines extending from the seat through edges of the obstruction.

3. The method according to claim 2, wherein determining an obstructed area further includes determining a set of intersection points formed by the set of projection lines intersecting with a perimeter of a viewing area.

4. The method according to claim 3, wherein determining an obstructed area further includes determining a polygon that defines the obstructed area based on the set of intersection points.

5. The method according to claim 1, further comprising displaying the seating information through a graphical user interface.

6. The method according to claim 1, wherein the assembly facility is one of an arena, coliseum, concert hall, convention center, events center, lecture hall, opera house, race track, sports venue, stadium, theater, and velodrome.

7. The method according to claim 1, wherein the seating information includes a three-dimensional perspective view of the viewing area.

8. The method according to claim 1, wherein the obstructions are represented by at least one of two-dimensional graphics, three-dimensional graphics, and text describing an obstructed area percentage.

9. The method according to claim 1, further comprising:
calculating a distance between at least two positions in the assembly facility; and
displaying the value of the distance.

10. The method according to claim 1, wherein determining the position of a seat in an assembly facility includes determining the coordinates for the perimeter of a field of the assembly facility, determining the coordinates for the first seat in a seating section based on the coordinates for the perimeter of the field, and determining the coordinates of a second seat in the seating section based on the coordinates of the first seat.

11. A server for providing seating information associated with a seat in an assembly facility, comprising:
a memory configured to store seating information associated with each seat in an assembly facility, the seating information including information regarding obstructions;
a communications interface configured to receive a seating information request for a selected seat from a client; and
a processor configured to transmit seating information associated with the selected seat to the client in response to the seating information request.

12. The server according to claim 11, wherein the seating information includes graphical views of at least one of viewing area perimeter and seating sections.

13. The server according to claim 11, wherein the seating information is an image file.

14. The server according to claim 11, wherein the image file includes at least one three-dimensional perspective view from the seat in the assembly facility and textual information regarding the obstruction.

15. A computer system for generating and providing seating information associated with a seat in an assembly facility, comprising:
a computer being configured to determine the position of a seat in an assembly facility, to determine the position of an obstruction in the assembly facility, to determine an obstructed area based on the positions of the seat and the obstruction, and to generate seating information based on the determined obstructed area; and
a server in communication with the computer, the server being configured to receive the seating information from the computer and to store the seating information in memory, the server further being configured to transmit the seating information to a client in response to a request from the client.

16. The computer system according to claim 15, wherein the seating information is an image file.

17. The computer system according to claim 16, wherein the image file includes at least one three-dimensional perspective view from the seat in the assembly facility and textual information regarding the obstruction.

18. The computer system according to claim 17, wherein the textual information includes at least one of the percentage of the viewing area that is obstructed and the identification of objects that are obstructed.

19. The computer system according to claim 15, wherein the computer determines the position of the seat in the assembly facility by determining coordinates for a perimeter of a field in the assembly facility, determining coordinates for a first seat in a section of the assembly facility based on the coordinates for the perimeter of the field, and determining the coordinates for the seat in the assembly facility based on the coordinates for the first seat in the section.

20. The computer system according to claim 15, wherein the server includes the computer.
